(19) United States
(12) Patent Application Publication
(10) Pub. No.: US 2022/0092992 A1
(43) Pub. Date: Mar. 24, 2022

(54) UNMANED AIRCRAFT OPERATING CONTROL SYSTEM AND METHOD

(71) Applicant: ARBOREA INTELLBIRD, S.L., Villamayor (ES)

(72) Inventors: Carlos BERNABEU GONZALEZ, Villamayor (ES); Aaron GONZALEZ HERNANDEZ, Villamayor (ES)

(73) Assignee: ARBOREA INTELLBIRD, S.L., Villamayor (ES)

(21) Appl. No.: 17/277,576

(22) PCT Filed: Sep. 18, 2018
(86) PCT No.: PCT/ES2018/070607

§ 371 Date: Mar. 18, 2021

(51) Int. Cl. G08G 5/00; B64C 39/02

(52) U.S. Cl. CPC G08G 5/0021; B64C 2201/146; B64C 2201/141; B64C 39/024

(57) ABSTRACT

An unmanned aircraft operating control system and method operates to prevent the aircraft from taking off if a flight clearance has not been requested or a positive clearance has not been granted. The system comprises software handled by the clearance applicant and a web application that processes and sends an encoded file to the proximal software, said encoded file containing a clearance type and a set of coordinates. The encoded file is executed at the beginning of the flight, with the intervention of an electronic board which upon the starting up of the aircraft causes the blocking of the aircraft's control means and sends a radio message to the proximal software, only answerable if the encoded file contains a positive clearance and the flight operator's space and time location falls within an authorized range, in which case the reception of the response message in the electronic board unblocks the aircraft.

### TECHNICAL FIELD

The invention relates to techniques for regulating the flight of an unmanned aircraft and more specifically to a system that comprises means for blocking the aircraft, preventing its operation where a take-off clearance has not been requested or where it has been refused. The invention also refers to a method whose implementation makes use of the claimed system and which comprises a clearance request step and an execution step.

### BACKGROUND OF THE INVENTION

The constant development of unmanned aircrafts (also known as Unmanned Aerial Vehicles UAV, including autonomous aircrafts and remotely piloted aircrafts) technology has led to an ever-increasing use of these devices, both for leisure and for professional purposes, such as surveillance, infrastructure testing or transportation. Flying of UAVs poses serious safety risks, as they can interfere with civilian or military aircrafts, intrude into military installations or strategic infrastructures, collide with buildings or telecommunication antennae, or crash into populated areas. Accordingly, governments have enacted a wide range of regulations defining restricted fly areas and subjecting UAV operation to strict requirements and heavy liabilities, such as hefty fines or even criminal responsibility for the management of the operating company. However, it is difficult for a flying operator to be aware of all restrictions that apply to a specific flight since, for instance, the air traffic control authority may have issued a NOTAM (Notice to Airmen) establishing a restriction due to a sporting event.

In response to this, a variety of technical solutions have been developed aiming at facilitating operators' compliance with the applicable legal requirements and to ensure a safe fly. Some techniques need the preinstallation of costly infrastructures such a transponder network, requiring the intervention of the public authorities. Others are based on geofencing, presenting the problem that due to a lack of updating recently issued NOTAMs may not have been taken into account. Other known systems are based on interfering with the aircraft's GPS, forcing the aircraft to land in certain situations.

Some patent documents disclose systems or methods for planning routes that take into account the obstacles to be encountered by the flying device, such as buildings or restricted areas. In WO2016154551A1 (MATTERNET INC et al) 29 Sep. 2016, “Route planning for unmanned aerial vehicles”, a processor, after receiving both a route request for a UAV and geospatial information (comprising obstacles associated with the origin and destination locations) determines a route which is communicated to the UAV through wireless communication. Another example in this line is US2012158280A1 (BOEING CO) 21 Jun. 2012, “Computing route plans for routing around obstacles having spatial and temporal dimensions”, where a route for a flying vehicle is defined through a graph by calculating a trajectory between a first destination and a second destination, and so on, adding the destinations to the route when the trajectory is not intersecting an obstacle such as restricted airspace.

Some other documents are concerned with diverting the flying device when it approaches or has entered an obstacle, such a restricted fly area. Thus, US2004249519A1 (FRINK BENTLEY D.) 12 Sep. 2004, “System and methods for preventing unauthorized use of aircraft” refers to an aircraft having a memory loaded with geolocation data which corresponds to restricted airspace boundaries. Where the aircraft approaches within a predetermined distance from the restricted area, it is rerouted by a flight computer. US2016240087A1 (AEROBOTICS INNOVATION LLC) 18 Aug. 2016, “System and method or preventing and remedying restricted area intrusions by unmanned aerial vehicles”, describes a system comprising a restricted area aggregator (16) and a UAV controller (14a) including an intrusion prevention module that determines whether the UAV is currently intruded within a restricted area.

Yet another set of patent documents refers to obtaining flying permission for an UAV. In KR20160074897A1 (KOREA ELECTRONICS TECHNOLOGY INST) 29 Jun. 2016, “Method and apparatus for allowing right of flight of drone” a drone control device receives a request signal for a given route during a given time. A processor grants or denies the permission according to existence of restricted areas or UAV flying prohibitions. Also, the route can be automatically adjusted to avoid congested areas. However, the apparatus does not include any device envisaged to prevent the UAV from actually flying in the event that permission is refused.

WO2017084031A1 (SZ DJI TECHNOLOGY CO LTD) 26 May 2017, “System and methods for managing fly restrictions regions” discloses a method based on UAV identity information or user identity information. The method comprises assessing whether the location of the UAV falls within flight restriction regions, obtaining a request for the UAV to fly within a restricted region, prior to granting or denying permission to fly within such region. The request can be made in advance prior to the UAV flying towards the flight restricted region. The request may comprise an identification of a proposed flight plan or fly area for unlocking. The identity of the UAV or its user is authenticated prior to granting or denying permission. The granting or denying of permission generates one or more flight response measures. These measures may govern whether take-off is allowed. However, the method does not comprise sending an encoded file from a remote web application to a software used by the flight operator. And it does not comprise means for blocking the UAV that work as claimed by this patent.

### SUMMARY OF INVENTION

The aim of this invention is to provide an unmanned aircraft (UAV) operating control system and method which, making use of easy-to-install blocking means, prevent the UAV from taking off if such flight is not permitted due to circumstances relating to the place and time in which the flight would be performed, or due to specific situations relating to the flight operator or the aircraft. In this patent, the term “flight operator” may designate a pilot, that is, the person in charge of handling a remotely piloted UAV or a group of UAVs in interconnected flight (UAV swarm). “Flight operator” may also designate the natural person or legal person that is responsible for a UAV (or a swarm) in autonomous flight. In this patent the terms “UAV” and “aircraft” are equivalent and designate both remotely piloted aircrafts and autonomous flight aircrafts (unless express reference is made to one or the other type) as well as an aircraft swarm, which for these purposes must be treated as a single aircraft.

In a first aspect, the invention relates to an unmanned aircraft operating control system. The system comprises proximal software and a web application. “Proximal software” means software handled by the flight operator. In one embodiment, the proximal software is a mobile device application, that is, it has been designed to run on mobile telecommunication devices such as a smartphone, tablet, laptop or any other portable device permitting a telematic communication, including via Wifi. The mobile telecommunication device must feature a positioning system by satellite or other technology.

In another embodiment, the proximal software is divided in two parts: one part is software (a mobile app, software stored in a non-portable personal computer or in an intranet server) used by the flight operator and capable of telematic communication (a positioning system not being required). The other part is software stored in a microprocessor, the microprocessor being integrated in a fixed telecommunication device located in the proximity of the aircraft, for instance, such location can be on the take-off and landing base (known as nest) of the autonomous aircraft, such software being capable of radio communication with the aircraft.

“Web application” must be understood as software which is used by accessing a web server through internet or an intranet. The web application is hosted in a remote computing device, in the sense that said remote device is different from the device where the proximal software is stored. Typically, the web application will be under the control of a person other that the user of the proximal software, for instance, a private company providing a UAV's operating control service or a public agency responsible for air traffic control. The person having the web application under his control is referred in this patent as “service manager”. The proximal software and the web application are interconnected, the user of the proximal software being able to access the web application through a mobile telecommunications device or through a browser.

The system comprises blocking means installed in a UAV. “Blocking means” must be understood as the means that prevent the aircraft from taking-off. The blocking means are characterized in that they operate by interposing themselves between the UAV's power source and the UAV's control devices. In one embodiment, the blocking means comprise a printed circuit board (1), also referred in this patent as “electronic board”, powered by the battery of the UAV and switching on when the UAV starts up. The board (1) comprises computing execution means, meaning any computing device equipped with a programmable memory and capable of executing instructions received through communications ports or stored in its memory. In one embodiment, said means comprise a microcontroller (3).

In a first moment, that takes place when the aircraft starts up and accordingly the microcontroller (3) is switched on, the microcontroller (3) transmits instructions to interrupting means (7, 9), with the effect that the aircraft's take-off is prevented. By “Interrupting means” is understood any device which, constituting an integral part of the blocking means (1), possesses the capability of interrupting and resuming the power transmission to the means of control of the aircraft. By “means of control of the aircraft” is understood any of its devices which are necessary to control the aircraft and whose stoppage prevents the aircraft from taking-off.

In a second moment, the aircraft being blocked, the microcontroller (3), after communicating via radio with the proximal software, and depending on the result of such communication, may send instructions to the interrupting means (7, 9). If such instructions are sent, the effect will be the unblocking of the aircraft.

After unblocking the aircraft, the blocking means (1) will be disabled, so there will not be any chance of an in-flight accidental intervention of the blocking means (1).

In a second aspect, the invention relates to an unmanned aircraft operating control method comprising two steps: clearance and execution. The clearance step begins at the request of the flight operator, its end being to obtain a positive clearance. During this step, the method is performed through telematic communication between the proximal software and the application web. First there is a clearance request, including indications about space and time in which the flight is intended. This step goes on with the processing of the request by the application web and ends with sending an encoded file to the proximal software. The contents of the encoded file comprise one type of clearance response (positive or negative), and space-time coordinates.

The execution step is based on the interaction between the proximal software and the blocking means on board the UAV, without any intervention of the application web. The aircraft must be located within the spatial and temporal range in respect of which clearance was requested. Upon starting up the aircraft, and by the intervention of the blocking means, the aircraft will not be able to take off. Depending on the contents of the encoded file, i.e. whether or not a positive clearance response has been issued, and depending also on whether or not the aircraft is within the space and temporal range in respect of which clearance was requested, the aircraft will either be able to take off or will be unable to do so.

### BRIEF DESCRIPTION OF DRAWINGS

FIG. 1: Components of the electronic board, on one side.

FIG. 2: Components of the electronic board, on the other side.

FIG. 3: Diagram representing the clearance step of the method.

FIG. 4: Diagram representing the execution step of the method, in a first embodiment.

### DESCRIPTION OF EMBODIMENTS

In a first aspect, the invention refers to an unmanned aircraft operating control system. The following elements intervene in said system: a) proximal software; b) a web application, hosted in a remote computing device. The web application is accessible by means of the proximal software, because they are interconnected; and c) blocking means installed in the UAV, said means comprising an electronic board (1).

In a first embodiment, primarily applicable to the operating control of remotely piloted aircrafts, the proximal software is a mobile device application, hosted in a mobile telecommunications device, for instance, a smartphone, which is in possession of the pilot. In a second embodiment, primarily applicable to the operating control of autonomous flight aircrafts, the proximal software has two parts: one is stored in a non-portable personal computer with telematic communication capacity. And the other part consists of software stored in a microprocessor which is integrated in a nest. The microprocessor can communicate via radio with the aircraft. The other two components of the system, that is, the web application and the blocking means, are the same irrespective of their use in connection with remotely piloted or autonomous flight aircrafts.

The web application which forms an integral part of the system has the capacity to receive in real time by telematic means information from external sources, for instance, NOTAMs, particularly from State air traffic security agencies, control towers and weather stations. The web application includes a computing database containing at least two kinds of data: a) relating to the identify of operators and aircrafts registered with the service manager, and b) relating to legal requirements applicable to UAVs' flight in the territory under responsibility of the service manager, such as aeronautic qualifications and certifications in possession of the flight operators registered with the service manager and flight prohibitions or restrictions applicable within said territory.

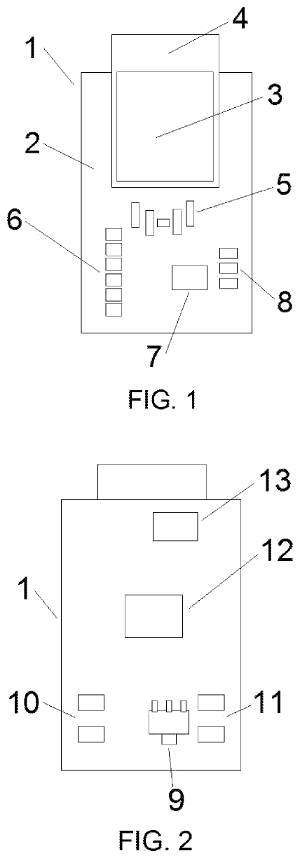

The blocking means comprise a blocking board, which in a preferred embodiment is a printed circuit board (1) which as shown in FIG. 1 comprises, on a base (2) of any material known in the art, the following elements in one of its sides: computing execution means, specifically a microcontroller (programmable logic device) (3) with at least one core processor, preferably of 32 bits and a low power coprocessor. The microcontroller has integrated communication ports (4) for communications via Wifi and Wireless Personal Area Network according to Bluetooth® standard or other radio communication systems. The microcontroller (3) is programmed using components (5) known in the art, through a programming port (6). Lastly, in this side of the board (1) there are interrupting means, specifically an optocoupler (7) with its associated output port (8).

In the opposite side, as shown in FIG. 2, the printed circuit board (1) comprises other interrupting means, namely a solid-state relay (9) with associated input (10) and output (11) ports.

The solid-state relay (9) switches off the power to the aircraft's peripheral devices, such as the inertial measurement unit (IMU), the main control board or the radio receiver. The optocoupler (7) disables the internal electrical voltage regulators, preventing the power supply to the different peripheral devices of the aircraft's main control board. With respect to these interrupting means, the electronic board (1) can have two configurations: one in which both the optocoupler (7) and the solid state relay (9) are operative, and another one in which only one of them is functioning while the other is not. The expert may select one configuration or the other depending on the technical features of the aircraft to which the electronic board (1) is to be installed.

Finally, the electronic board (1) comprises powering means, namely an integrated switched-mode power supply (12), connected to the aircraft's battery by means of a supply port (13).

The electronic board (1) can be installed to any UAV, either a remotely piloted or an autonomous flight aircraft. It is not necessary that the electronic board (1) is installed at the factory or that the UAV features any element designed for eventually fitting it. Installation of the electronic board (1) only requires making the connections between certain components of the board (1) and certain components of the UAV, plus programming the microcontroller's (3) firmware, the expert in the art being able to perform these operations in view of the foregoing description.

In a second aspect, the invention refers to an unmanned aircraft operating control method, which is implemented using the system which has been described.

In order to implement the method, the flight operator must be registered on the web application's database. If the operator is a pilot, the registration will be subject to compliance with the applicable requirements concerning qualification as pilot and any other legal requirements. Likewise, the UAV to be used in the operation in respect of which clearance is requested must have been registered on said database, compliance with airworthiness and other requirements being necessary to this end. Where an operator is registered, a password is issued. Where an aircraft or a swarm of aircrafts are registered, an identification code is assigned. An operator's password is not associated to any specific aircraft's identification code. Thus, particularly in the case of companies operating an aircraft fleet, the operators will be able to choose any aircraft from the fleet to carry out a requested flight.

The method comprises two main steps: clearance and execution. Clearance is performed in the same way irrespective of the method being performed with a remotely piloted or an autonomous flight UAV. The execution step is different depending on the type of aircraft.

The clearance step must begin with anticipation to the moment foreseen to commence the flight. This step must be performed in an environment within mobile phone network or Wifi range, because it needs communication via web between the proximal software and the web application.

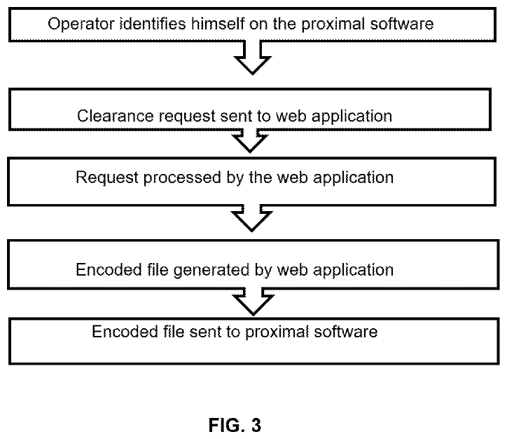

FIG. 3 shows a flow chart of the different substeps comprised in this step of the method: 1) Identification of the operator, using the issued password. 2) Clearance request, entering the information requested by the proximal software interface, comprising space indications (geographical area of flight and maximum elevation), time (range of dates to carry out the flight, starting time and estimated length) and type of operation (for instance, powerline inspection). This information is telematically transmitted to the web application. 3) Processing by the web application of the information provided by the operator, comprising cross-checking it against the information received in real time from external sources, primarily with NOTAMs issued by the competent authorities and against the information stored in the web application's database. 4) Generating by the web application of an encoded file, whose content comprises two blocks.

The first block specifies one type of clearance, which can be: a) positive clearance, with two subtypes: a.1) unconditional with respect to the requested flight parameters, and a.2) limited with respect to the requested flight parameters, for instance, with a lower range of dates, or at a lower elevation; b) negative clearance result, with two subtypes: b.1) absolute, and b.2) revocable, if the deficiencies are corrected (for instance, applicant needs to obtain a flight permit to overfly a National Park), which would generate a new answer consisting of a positive clearance.

In the second block, the encoded file contains space-time coordinates referring to the geographical and time range in respect of which a positive clearance has been granted. If the clearance has been negative, the encoded file will not contain such second block.

The encoded file is stored in the proximal software and can be checked by the operator at all times. This way, the operator will know which type of clearance has been issued and if something needs to be corrected. This can avoid unnecessary travelling to the starting point of the desired flight.

Concerning the second step of the claimed method, that is, the execution step, two embodiments shall be described. In the first one, applicable to the operating control of a remotely piloted aircraft, the flight operator is a pilot. The proximal software is a mobile application downloaded in a smartphone in the possession of the pilot.

In this first embodiment, the pilot must place himself, with the registered aircraft that he intends to use in the operation, in a point within the space range in respect of which clearance was requested and at an authorized time. As this stage is based on the radio communication between the mobile application and the electronic board (1), it can be performed in areas out of mobile phone or Wifi range.

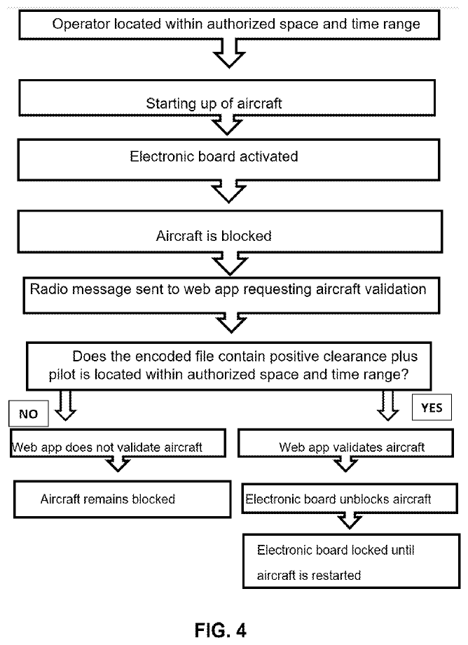

The execution step comprises the following substeps, as shown in FIG. 4 flow chart: 1) Starting up the aircraft, an action which activates the electronic board (1). In this moment, by the interaction of said board (1) with the aircraft's components, the aircraft will be unable to fly. 2) Said action causes the electronic board (1) to automatically send, via radio communication, a message to the mobile application, said message containing the aircraft's identification code and a request to the pilot to validate the aircraft, that is, to confirm that such aircraft, identified with a code shown in the screen, is the one to be used in that flight operation. If, within the range of the communication system, several registered aircrafts were started up in a close interval, each pilot's mobile application would receive validation messages in respect of all of them, hence that, as a security measure, the pilot must validate the specific aircraft under his charge. 3) Aircraft validation is effected by a validation message, sent via radio by the mobile application to the electronic board (1), reception of which causes the unblocking of the aircraft, enabling it to fly.

The actual sending of the validation message by the mobile application is subject to two conditions, which are simultaneously verified by the mobile application through the execution of the encoded file: a) that the type of clearance contained in the encoded filed is positive; and b) that the validation message is sent from the mobile application from a space point and at a time comprised in the range of space-time coordinates contained in the encoded file, which implies that the pilot is physically located, with the aircraft, within said area. This fact is checked by the application by crossing the space-time coordinates contained in the encoded file with the same type of coordinates obtained by the positioning system of the pilot's mobile device.

Where the clearance contained in the encoded file is negative, the mobile device application will not send the validation message to the aircraft's electronic board (1): thus, even if the pilot—that was or could have been aware, when he received the encoded file, that a positive clearance had not been granted—tries to fly the UAV and therefore answers the validation request issued by the electronic board (1), the validation message will not be sent by the pilot's mobile application. In such an event, a warning that there is no positive clearance for that flight will show in screen. The same warning will be generated if the pilot attempts to validate the aircraft outside the authorized space or time range. In this way, the aircraft can only be operated by an authorized person that is located within the permitted space and time range.

A second embodiment of the execution stage is applicable to the operating control of autonomous flight aircrafts. It is performed with a system comprising a proximal software which is divided in two parts: one part is stored in a computer the user of which is the flight operator, and the other part in a microprocessor integrated in an aircraft's nest.

This stage of the method is substantially the same as in the first embodiment, so only the differences will be described hereinafter. The basic difference is that the encoded file is sent from the web application both to the computer used by the flight operator and to the microprocessor integrated in the nest. The first file allows the operator to know if the clearance is positive or negative, so that, if applicable, the necessary corrections or planning can be made. The second encoded file is the one actually intervening in the performance of the method. Thus, once the autonomous flight aircraft starts up at the programmed time, and the electronic board (1) is activated (preventing the aircraft from flying), the electronic board (1) in the aircraft will send the validation request to the proximal software stored in the microprocessor located in the nest. Therefore, the encoded file will be executed by the software stored in the microprocessor, that will check if the two above-mentioned conditions are met (positive clearance and aircraft located within authorized space and time range). If so, this microprocessor will send the validation message via radio to the electronic board (1), reception of which will unblock the aircraft.

Having described the system and method, it is hereinafter explained how the electronic board (1) intervenes in the performance of the method, such intervention being the same regardless of whether the method is performed with remotely piloted or with autonomous flight aircrafts. When the aircraft starts up, the switched-mode power supply (12) takes its power from the aircraft's battery through its supply port (13), switches off the microcontroller (3) and enables the blocking means (1). Instantaneously, the microcontroller (3) enables the interrupting means (7, 9), blocking the aircraft, which will not be able to take off. This enablement of the interrupting means (7, 9) can be effected by direct or inverse logic. Almost simultaneously, the microcontroller (3) sends through its communication ports (4) a radio message to the proximal software requesting validation of the aircraft. If and when the microcontroller (3) receives the validation message sent by the proximal software, it will disable the interrupting means (7, 9), thus unblocking the aircraft, which will enable it to take off. Immediately afterwards, the microcontroller (3) will lock itself and thus, the blocking means (1) will be disabled. The aircraft will fly without any interference from the blocking means (1), avoiding any risk of in-flight blocking of the aircraft. To restart the microcontroller (3) it is necessary to restart the aircraft, which requires disconnecting its battery.

1-14. (canceled)

15. An unmanned aircraft operating control system comprising:
proximal software; and
a web application;
wherein there are blocking means installed in the aircraft between its power supply and its flight control devices; and
wherein said blocking means comprise powering means and computer execution means.

16. The system of claim 15, wherein the blocking means further comprise means for interrupting the power supply of at least one control device of the aircraft.

17. The system of claim 16, wherein the blocking means are configured to enable the interrupting means after starting up the aircraft and to disable the interrupting means after receiving a validation message from the aircraft.

18. The system of claim 17, wherein the computer execution means are configured to lock themselves once the interrupting means have been disabled.

19. The system of claim 15, wherein the proximal software is divided in two parts, one part stored in a computer device handled by the flight operator and another part stored in a microprocessor integrated in a fixed device, said fixed device being located in the proximity of the aircraft.

20. An unmanned aircraft operating control method, comprising the steps of:
requesting a clearance by sending the request from proximal software to a web application;
sending an encoded file from the web application to the proximal software, the encoded file comprising a clearance type; and
executing the encoded file through the radio communication between the proximal software and blocking means installed in the aircraft.

21. The method of claim 20, wherein the execution of the encoded file is effected from a space point and at a time which must be comprised within space-time coordinates contained in the encoded file.

22. The method of claim 20, wherein the execution of the encoded file comprises starting up the aircraft and sending up afterwards, from the aircraft's blocking means, a radio communication to the proximal software, requesting aircraft validation.

23. The method of claim 22, wherein aircraft validation is effected by sending via radio a validation message from the proximal software to the blocking means of the aircraft.

24. The method of claim 23, wherein sending the validation message requires that the clearance type contained in the encoded file is a positive clearance.

25. The method of claim 22, wherein starting up the aircraft causes the enablement of its blocking means.

26. The method of claim 25, wherein the aircraft validation causes the disablement of the aircraft's blocking means.

27. The method of claim 20, wherein the execution of the encoded file is performed by the proximal software which is stored in a microprocessor integrated in a fixed device located in the proximity of the aircraft.
